(19) United States
(12) Patent Application Publication
(10) Pub. No.: US 2003/0186200 A1
(43) Pub. Date: Oct. 2, 2003

(54) System and method of instruction

(75) Inventor: George Selix, Flanders, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: TM Acquisition Corp., Las Vegas, NV

(21) Appl. No.: 10/404,309

(22) Filed: Apr. 1, 2003

Related U.S. Application Data
(60) Provisional application No. 60/369,283, filed on Apr. 2, 2002.

(51) Int. Cl. G09B 19/00

(52) U.S. Cl. 434/219

(57) ABSTRACT

A method and system of providing instruction regarding real estate, including providing instruction from an instructor to a student at one via a network such that the instructor and the student can communicate in real-time, instructing the student to access and review pre-stored text and graphics available via a node of the network, instructing the student to complete related exercises, and instructing the student to obtain additional related in-person instruction.

### CROSS-REFERENCE TO RELATED APPLICATIONS

The present application claims priority from U.S. Provisional Application No. 60/369,283 filed Apr. 2, 2002, the disclosure of which is hereby incorporated by reference herein.

### BACKGROUND OF THE INVENTION

There is a need for providing affordable, frequent, and accessible learning opportunities to real estate agents. For example, Century 21 has had tens of thousands of members working at thousands of offices, yet only a few thousand of its agents receive initial training each year.

Although many of these agents can be trained via live, on-site fundamentals classes, the live, on-site classes have limitations. From a frequency point of view, the number of trainers on staff can limit the number of events that can be conducted in any given year. Smaller markets may also receive fewer classes and even large markets may see gaps between classes of several weeks. From an accessibility point of view, the attendee is often required to travel long distances to attend the training. From a content point of view, the volume of content may require a lecture format, with limited opportunity to practice new skills. Renting computer equipment for each class can be prohibitively expensive, such that no hands-on skills are taught or practiced.

Accordingly, there is a need to both decrease the cost of training and increase the number of participants.

### SUMMARY OF THE INVENTION

The present invention provides a system and method for providing instruction using four different, and integrated, modalities. The modalities include:

(a) providing synchronous, on-line instruction relating to a subject time from one node of a network to another node of a network such that the instructor and students can communicate in real-time;

(b) providing asynchronous, on-line instruction relating to a subject from one node of a network to another node of a network by transmitting pre-stored text and graphics to the student;

(c) providing asynchronous, off-line instruction relating to a subject by providing the student with text and graphics without the use of the network; and

(d) providing synchronous, off-line instruction relating to a subject by providing the student with in-person instruction.

The students are referred to each modality by at least one other modality.

Preferably, the subject relates to real-estate, the students are agents and the in-person instructor is employed by a broker.

It is also preferable that the synchronous, on-line instruction be provided via the Internet or another large-scale network and refers students to the asynchronous, on-line modality by identifying another node on the same network.

It is further preferred that the synchronous, on-line instruction refers students to the asynchronous, off-line modality by referring the student to previously-provided material, and the synchronous, on-line instruction refers students to the synchronous, off-line modality by referring the student to a broker.

The provider of the synchronous, on-line may certify the student by receiving notice from the synchronous, off-line instructor that the student understands the materials provided during the asynchronous, off-line instruction.

### BRIEF DESCRIPTION OF THE FIGURES

FIG. 1 is a conceptual framework in accordance with an aspect of the invention.

FIG. 2 is schematic diagram of infrastructure in accordance with an aspect of the invention.

FIG. 3 is a sample screen shot in accordance with an aspect of the invention.

FIG. 4 is another sample screen shot in accordance with an aspect of the invention.

FIG. 5 is a another sample screen shot in accordance with an aspect of the invention.

FIG. 6 is an illustration of the relationship between objectives, modality and media.

### DETAILED DESCRIPTION OF THE PREFERRED EMBODIMENTS

The present invention provides a system and method for delivering instruction in an integrated, multi-modality infrastructure.

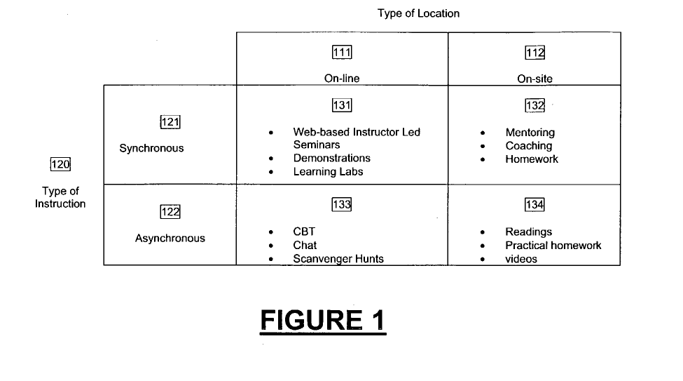

FIG. 1 illustrates a conceptual framework of the system. Two sets of dichotomous choices can be used based upon the mode of instruction 120 and location 110.

The mode of instruction 120 can be synchronous 121 or asynchronous 122. A synchronous mode 121 is one in which the instructor provides the course material live, i.e., in real-time to the student. An asynchronous mode 122 is one in which course material is pre-recorded or stored and can be provided to the student at any time.

The type of location 110 can be on-line or on-site. In an on-line locale 111, the course material is provided to the agent via a network. In an on-site locale 112, the course material is provided without the use of a network.

Each cell of the conceptual framework in FIG. 1 represents a different modality, as determined by the particular intersection of the type of instruction 120 and the type of location 110.

Synchronous/On-line Modality 131 is the foundation of most courses. For example, this mode may include web-based Instructor Led Seminars (ILS) whereby the instructor provides instruction to the agents via the web. These seminars are used to introduce and explain concepts, demonstrate procedures, and answer questions in real-time. The Synchronous/On-line Modality 131 allows the instruction to be provided at significantly reduced delivery costs (such as travel) than live in-person classes. Moreover, because travel is unnecessary and expense is reduced, it is possible to increase both the frequency and accessibility of the course. For example, one instructor can reach the entire nation multiple times each day.

Preferably, the duration of a single session in the Synchronous/On-line Modality 131 is limited to about two hours and the student:teacher ratio is limited to about 30:1 to increase interactivity. Although these limitations often result in a multi-day course, spacing the instruction over time provides advantages over longer single-day courses. Other real-time, on-network types of instructions include learning labs and demonstrations.

Asynchronous/On-line Modality 133 is used to add depth and breadth to Synchronous/On-line Modality 131. In this modality, materials are stored on the network and are available for downloading and review at the agent's request. Preferably, Asynchronous/On-line Modality 133 provides web-based training on topics that tend not to not to raise a lot of questions for the student. For example, a topic may be the procedural use of a productivity tool, such as teaching students how to use productivity software like Microsoft PowerPoint. Asynchronous/on-line instruction also permits on-line and web-based activities such as “scavenger hunts”, whereby students are required to visit various nodes of the network such as websites, and obtain specific bits of information required during class or for other homework assignments. This session may also include chats.

While some audio and video streaming may be provided in connection with Asynchronous/On-line Modality 133, it is often preferable to provide instruction in this modality via animated graphics and text in order to keep bandwidth requirements relatively low. Another benefit of asynchronous/on-line instruction is that it provides increased student comfort level with the web in general, acting in the background as a transparent learning event.

Asynchronous/On-site Modality 134 provides off-line, asynchronous activities that are performed without the need of a network or live instructor during the agent's learning. By way of example, asynchronous/on-site instruction may include: videos in either VHS or CD format when motion, processes, or human interaction needs to be modeled or demonstrated; workbooks and readings; and other homework. Giving students something to hold and “show off” tends to be both an excellent reinforcement and recruiting tool. Asynchronous/on-site instruction is preferably tied to those activities that either localize the training or build good business habits.

Synchronous/On-site Modality 132 provides live in-person instruction. For example, the instruction may be provided by the agent's mentor or coach at the brokerage. While the other three modalities 131, 133, 134 can deliver content anywhere in the country, Synchronous/On-site Modality 132 is preferably tailored to local business needs, which is particularly advantageous to real estate training. In this regard, the broker has the opportunity to introduce its company culture inside the context of the national brand.

Preferably, Synchronous/On-site Modality 132 includes providing the local business unit manager with a guide to account for local business conditions and for their unique corporate culture. The guide includes a spreadsheet that includes each day's learning objectives, readings, homework, and student expectations of their supervisor. In class, students are pointed to their local coach/mentor to answer the locally-oriented questions; in the spreadsheet, coach/mentors are warned about what is coming for the student and what the questions are. The coach/mentors may be provided with the answers or may be required to determine them on their own.

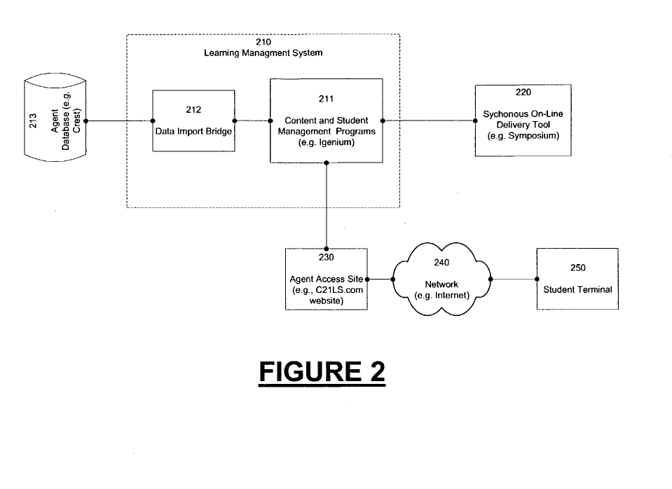

One possible embodiment representing the infrastructure 200 of the system and method is illustrated in FIG. 2. The infrastructure 200 generally comprises two main components: the Learning Management System (LMS) 210 and the Synchronous On-line Delivery Tool 220.

The LMS 210 manages the intersection of learning and performance by providing the tools necessary to determine whether the learning is increasing performance. Click2Learn's Ingenium (a.k.a. Aspen) product may be used to manage the content and students as part of the LMS 210 (FIG. 2). For example, the Student and Content Management Programs 211 provide software for managing and delivering course content, providing on-line classes, as well as managing and tracking student access, performance and attendance.

A data import bridge 212 connects the Student and Content Management Programs 211 to a back-end system for storing information regarding real estate agents. In one aspect, the back-end system comprises a database 213 for tracking personnel. When a broker hires a new agent and the information is placed in the database (such as Century 21's proprietary CREST system), the data import bridge 212 adds that person to the list of agents authorized to access the LMS 210. For example, the data import bridge 212 may import certain agent information from the database 213 on a weekly basis into the LMS.

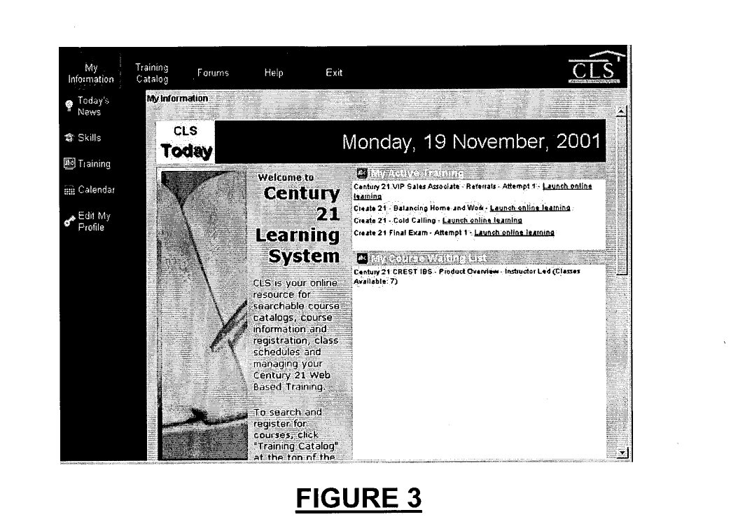

In the embodiment illustrated in FIG. 2, agent access to LMS 210 is provided via a web site 230 such as C21LS.com. The web site preferably provides a single jumping-off point for on-line learning activities. As is known in the art, the Aspen product provides the tools necessary to build a web site that provides student access and management as well as content delivery. Accordingly, in one aspect and as shown in FIG. 3, little customization is required other than providing cursory branding and appearance changes (such as by adding the logos and colors). Thus, the student terminal 250 is at one node of network 240 (such as the Internet) and the learning management system 210 is at another.

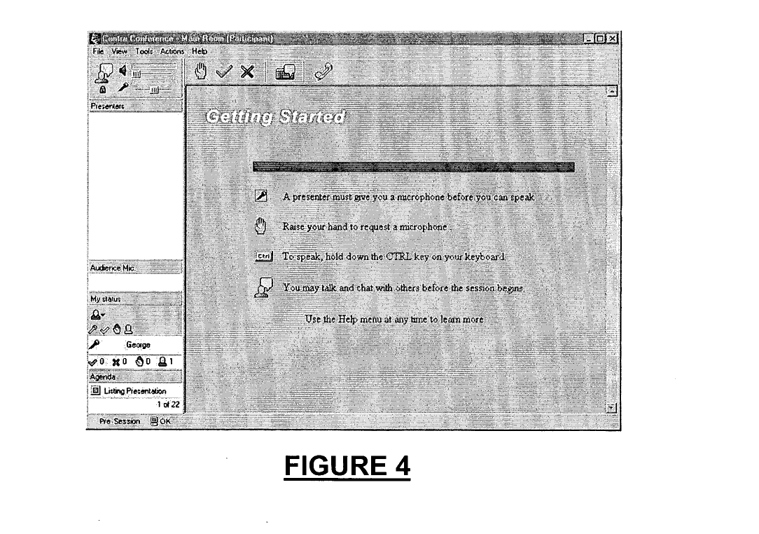

The On-line Delivery Tool 220 is used to build and deliver classes. Preferably, the tool provides high levels of interactivity and instructor presence, conducts in-class polling and testing, and archives live sessions for re-delivery on demand. In one aspect of the invention, the on-line delivery tool 220 comprises Centra's Symposium product. This product provides not only the foregoing features, but also provides the capability of conducting hands-on technology training sessions over the Internet. For example, as shown in the screen generated by Symposium and reproduced in FIG. 4, the on-line delivery tool provides functions such as handling and permitting agent's requests to ask questions from the instructor, and facilitating agent-to-agent chats before and after the instructional session.

Preferably, the infrastructure is configured to take into account the system requirements of the maximum number of students. For example, one goal may be to build an infrastructure that supports agents participating from home using a single dial-up connection to the Internet. Many agents only have a single phone line at home and, thus, require an infrastructure that allows shared use of voice and data over the same line. Voice Over IP functionality of Centra Symposium may be used in furtherance of this goal. In one aspect, the minimum system specifications are 28.8K dial-up through a proprietary ISP and a PIII, 200 MHz computer with 64 Mb RAM.

A course and method in accordance with one aspect of the invention follows. It should be understood that other courses and variations may be implemented in accordance with the present invention. This example is based largely on the Career Real Estate Agent Training and Education course known as CREATE 21 and the subject of real estate as it pertains to real estate agents.

The primary target group for CREATE 21 is new real estate agents with less than three months experience. One goal is to build a course that provides knowledge transfer, hands-on skills (psychomotor training), and practical business habit development. Each lesson introduces new material, attaches it to prior learning, demonstrates skills and, whenever possible, has students attempt the skill on-line. Homework is used to reinforce classroom lessons, but remains focused on meaningful activities (vs. traditional ‘fill-in-the-boxes’ homework that tests knowledge transfer but has little practical application).

The CREATE 21 course uses the Synchronous/On-line Modality 131 as its foundation. To keep the course a manageable size, it provides 12 live and on-line sessions totaling approximately 24 hours on instructor-led seminars. These lessons are used to introduce topics and demonstrate their use in typical real estate settings.

The live, on-line classes are further designed to maximize the interactivity between the students and instructors, creating a larger sense of instructor presence. To that end, classes are planned for a 30:1 student:teacher ratio. Usually, instructors force interaction at the group-level every 3-5 frames or 5 minutes. Even if the software supports it, multi-point video conferencing may be omitted until sufficient participants have broadband access. A primary task for the instructors is to tie the learning back to prior knowledge, to establish the student's schemata so that other content (primarily but not necessarily asynchronous) could easily attach. Thus, during the live on-line instruction, the students are instructed to: review materials on a web site after the live instruction is completed, complete exercises without the use of a network, and obtain additional information relating to the subject matter discussed during the class from the broker with which the agent is affiliated.

Accordingly, as explained in more detail below, students are instructed in one modality (in this case the Synchronous/On-line Modality 111) to pursue related material in all three of the other modalities.

Most classes include a number of homework assignments because, with only two hours to lecture, some material can't be covered in a single class.

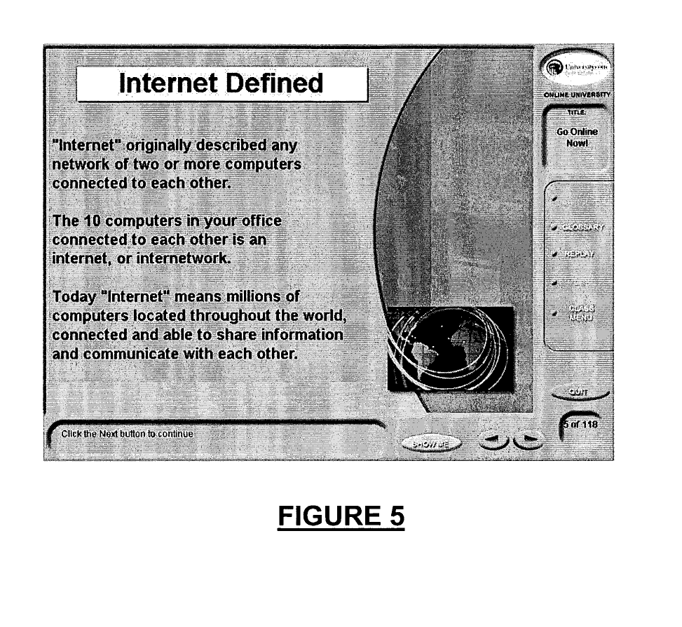

Some of the homework takes place in Asynchronous/On-line Modality 133, which provides pre-stored text and graphics relating to the information provided during the live, on-line class. During this mode, the material is transmitted over the network to the student. For example and as shown in FIG. 5, the material may be traditional computer-based training such as web pages containing additional information about the subjects covered during the prior class. The material is intended to reinforce the information learned in class and builds a business practice, such as placing names in a contact management system or completing on-line computer-based training (CBT) on personal marketing. It may also consist of web-based scavenger hunts or self-directed field trips.

Preferably, the material provided during the Asynchronous/On-line Modality 133 serves at least two learning goals. The first is the transfer of the appropriate knowledge contained in the class (the learning objective) and related homework. A secondary goal results from working on the web, allowing students to become more facile with technology and increasing their ability to use the technology while not actually receiving instruction on it. This “behind-the-scenes” learning arises in each on-line lesson.

The live, on-line class also refers the student to Asynchronous/On-site Modality 132 materials, which similarly provides text and graphics related to the information provided during the class, but it does so without the use of the network 240. Asynchronous, off-line assignments generally fall into a number of sub-categories, depending upon the media. A notebook may contain outlines and a note-taking device for each lesson. Supporting information is included as marginal notes in the workbooks. The books serve as a compilation of materials at the end of the course—they become a single-source reference for new agents after training. Each student may also receive at least one compact disk: this contains all of the video-based instruction on topics such as negotiating, maintaining personal space, and interviewing. CDs may be used in lieu of web-based streaming since many participants do not have access to broadband connections.

The three previous modalities preferably provide students with access to content developed and delivered by the national learning department staff. Thus, the fundamentals can be covered using multiple modalities and media. Advantageously, one aspect of the present invention also provides an additional level of customization so that the course can tailored to the student and the local business environment.

To this end, the method also includes providing related instruction via the Synchronous/On-Site Modality 132. Using the example of CREATE 21, it may be too expensive to attempt to accommodate the multiple degrees to which local issues relate to the nationally-developed materials. Accordingly, the CREATE 21 program provides a truly local component by distributing a “broker pack” to each broker or manager with a student in training. The broker pack acts as a guide for the mentoring/coaching of a new agent by the broker over the first 90 days the agent is at work. In this regard, the broker pack explains the learning activities and objectives that the student will be exposed to during training. It includes each day's lessons and the homework that the student will have to perform for each lesson. It further provides instruction on what specific content needs to be addressed at the local level. The package directs the broker to build appropriate packages of local/state/board forms to give to the students during relevant sessions and to develop the “canned” talks on corporate policy and climate that the agent will expect to hear.

Accordingly, in the live, on-line class, the instructor will teach a topic and direct the student to their manager to get the local information/implementation relating to that topic. The brokers/managers can then localize the national program, enculturate their new agent, and keep track of what is going on in class. After that, the broker's own mentoring/accountability system may be used.

The system also fosters content development. When developing content, instructional designers can begin in any cell and then lead to all of the other three cells. However, beginning in either asynchronous cell will tend to drive the designer to the other asynchronous cell. While on-site readings or videos can supplement computer-based training, it is more difficult to supplement on-site readings with a live class. For example, in a course where the student had to first read a book and then discuss it in a live class, the discussion would be the principal modality and the on-site reading a prerequisite. Preferably, the process includes multiple iterations: begin with the primary modality, add supporting content from other modalities and then start again.

A model for content evaluation known as the ADDTE model (Analyze, Design Objectives, Develop Media, Implement, and Evaluate) may be used for content development. Analysis provides knowledge of the learner's needs and the knowledge's, skills, and abilities deemed most important to success. It also defines desired outcomes in both behavioral and productivity terms, but in a very general sense. After analyzing the learner and desired outcomes, the next step is to design learning objectives for each course. Live, on-line sessions are used to introduce each topic and provide a general framework the addition of additional content. Both asynchronous modalities (on-site and on-line) are used to add that context or additional depth. The live, onsite sessions provide an opportunity to localize the content. In practice, a learning objective is determined, then enabling objectives, and finally, small elements of content. If the process is viewed as constructing a toy house from building blocks, smaller blocks are aggregated to become bigger blocks, which are aggregated to become major portions of the house. In order for a learner to proceed from declarative knowledge to application, most of the intermediate levels need to be addressed (although there are exceptions to this practice) In sum, first the facts are learned. Then facts are combined to develop and understand concepts. Concepts allow the development of procedures for standard operations. When new situations are faced, concepts and procedures are used to solve the problem. When the problems are solved, the knowledge is applied to accomplish the task at hand. One manner of assigning content development based on this taxonomy follows:

(a) Declarative: Objectives designed to pass on facts and figures. Use is split between live, on-line and asynchronous lessons. These are the easiest objectives to work with but quickly become the foundation for all of the other objectives.

(b) Conceptual: Primarily covered in live, on-line sessions. This is where students learn the basic relationships between major real estate transaction principles.

(c) Procedural: Step-by-step methodologies for accomplishing some task. Checklists are mentioned in live, on-line classes, but are primarily covered in asynch classes. In some offices, brokers have added procedures to the live, on-site modality.

(d) Problem Solving; Primarily accomplished during homework—either asynchronous mode.

(e) Application: The practical, live, on-site homework required for each class.

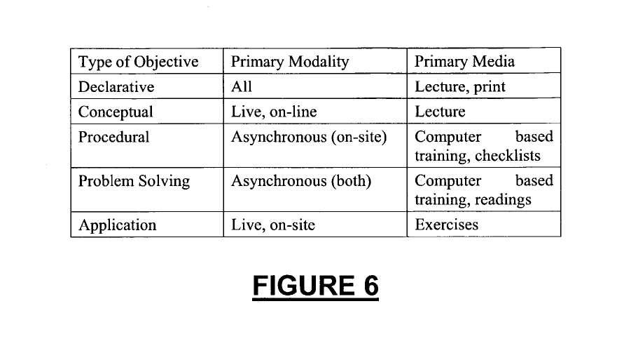

Understanding the objectives can lead to media design. While determining objectives, media and instructional strategies can also be chosen, including designing the on-line interactions (when to ask which question, how to keep students engaged). During the process, a course design framework may be used. It is preferable for each part of the course to be standards-based and template driven, which works advantageously with the system. Re-purposed CBT (asynchronous, on-line courses used from other sources) may be re-written or modified to be AICC compliant in order to work with the system. FIG. 6 shows the relationship between objectives, modality, and media.

The final two processes of ADDIE are to implement and then evaluate the learning. With respect to evaluation, immediate classroom feedback and ‘smile sheets’ may be used to gauge learner response to the material. Multiple formative and a single end-of-course summative evaluation are used to measure transfer. Agent productivity may be compared at monthly intervals to see if the course is having the desired effect on productivity.

The present invention provides a number of advantages over the prior art. One of the disadvantages of live interaction between agents and others more knowledgeable about real estate is the expense. In addition to the necessity of compensating the instructors in a classroom setting, there are also travel expenses and the cost of allocation resources such as classrooms. By providing live classes on-line, such expenses are eliminated. Even so, there are still costs associated with live, on-site instruction because of the facilitation costs and travel and lodging for the instructors. While these disadvantages are addressed by providing learning in either asynchronous modalities, the transfer effect is often lower, which is probably due to the lack of context or reference that pre-determined courses provide—a live instructor can find ways to attach new learning to existing knowledge (schemata) where an asynchronous course cannot.

Accordingly, the invention advantageously blends the features of each modality by integrating them with one another into a single course. Rather than concentrating on a single modality, or providing disconnected multiple modalities, it uses the advantages of the one modality as the foundation and leverages the other modalities as appropriate. For example, because it would be too expensive to accommodate multiple degrees of freedom in each live, on-line class, the on-line class refers the students to their local mentors to learn the local variant of the national subject they learned during class.

By using multiple modalities for the same subject, the invention also provides a new agent training program that can be delivered with a mix of media that leads to better knowledge transfer, hands-on skills training and fosters the development of exceptional business habits. By leveraging all four modalities, the invention provides unique advantageous that cannot be accomplished with a single modality.

Another advantage of the invention is its flexibility. For example, Asynchronous/On-site materials may be provided during Asynchronous/On-line instruction. In this regard, material to be read during Asynchronous/On-site Modality 134 may have been delivered as Adobe PDF-compliant files when the agent was on-line during Modality 133.

In addition, agent productivity numbers can be extracted from the Agent Database 213 into the Learning Management System 210 so that individual agent production can be tied to whatever learning they might have taken. Preferably, the database would further allow the agents' brokers to access the Learning Management System 210 to see student performance against learning. In this manner, the learning investment values can be calculated. The infrastructure 200 may also be comprised of other technologies and programs.

In another aspect of the invention, the Learning Management System may certify that the student completed the course by receiving notification from the broker/manager that the agent has successfully completed the materials provided in connection with the asynchronous/on-site modality.

Unless stated to the contrary, use of words such as “including,” “containing,” “such as,” “comprising” and the like, means “including without limitation” and shall not be construed to limit any general statement that it follows to the specific or similar items or matters immediately following it. Unless stated to the contrary, reference to “a” or “one” thing does exclude the possibility of using a plurality of such things.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims.

1. A method of providing instruction relating to real-estate comprising:
(a) providing instruction relating to real-estate subject matter from one node of a network to another node of a network such that the instructor and a real estate agent can communicate in real-time;
(b) during step (a), instructing the agent to access pre-stored text or graphics available via a node of the network wherein the text or graphics relate to the subject matter provided during step (a);
(c) during step (a), instructing the agent to complete exercises relating to the subject matter provided during step (a), such exercises being provided without the use of the network; and
(d) during step (a), instructing the agent to obtain in-person instruction relating to the subject matter provided during step (a) from a broker with which the agent is affiliated.

2. The method of 1 wherein the step of instructing the agent to access the pre-stored text or graphics comprises instructing the student to access text or graphics via a web site.

3. The method of claim 1 further comprising certifying the student by receiving notice from the broker that the student performed the exercises.

4. A method of providing instruction comprising:
(a) providing synchronous, on-line instruction relating to real estate from one node of a network to a node of a network associated with a student;
(b) providing asynchronous, on-line instruction relating to real estate from one node of a network to the node associated with the student by transmitting pre-stored text or graphics to the node associated with student;
(c) providing asynchronous, off-line instruction relating to real estate by providing the student with text or graphics; and
(d) providing synchronous, off-line instruction relating to real estate by providing the student with in-person instruction.

5. The method of claim 4 wherein the student is a real estate agent.

6. The method of claim 4 wherein the network is the Internet.

7. The method of claim 6 wherein the step of providing asynchronous, on-line instruction comprises transmitting information from a web site relating to real estate to the node associated with the student.

8. The method of claim 7 wherein the web site is identified during the synchronous, on-line instruction.

9. The method of claim 8 wherein the student is referred to more than one web site for asynchronous, on-line instruction.

10. The method of claim 4 wherein providing asynchronous, off-line instruction comprises providing written material.

11. The method of claim 4 wherein providing asynchronous, off-line instruction comprises providing videos on a medium.

12. The method of claim 4 wherein the step of providing synchronous, off-line instruction comprises a broker providing in-person instruction to an agent.

13. The method of claim 12 further comprising providing the broker with written materials relating to the subject matter of the instruction provided during the synchronous, on-line instruction.

14. The method of claim 4 wherein the step of providing synchronous, off-line instruction comprises providing information relating to the local-specific information and the step of providing synchronous, on-line instruction comprises providing information relating to non-local specific information.

15. The method of claim 4 further comprising certifying the student by receiving notice from the synchronous, off-line instructor that the student understands the materials provided during the asynchronous, off-line instruction.

16. A system for providing instruction relating to real-estate comprising:
a network of nodes;
means for providing subject matter relating to real-estate from one node of the network to another node of the network such that an instructor and a student can communicate in real-time;
means for transmitting text or graphics from another node of the network relating to the subject matter;
whereby during the provision of the subject matter from one node to another in real-time, the student is instructed to (a) access the pre-stored text or graphics, (b) complete exercises relating to the subject matter, such exercises being provided without the use of the network, and (c) instructing the student to obtain additional information relating to the subject matter from the broker with which the student is affiliated.

17. The system of claim 16 wherein the network is the Internet.

18. The system of claim 16 further comprising a database for storing information regarding real estate agents and means for authorizing student access by accessing the information from the database.

19. A method of providing instruction relating to real-estate comprising:
(a) providing instruction relating to real-estate subject matter from one node of a network to a student at another node of the network such that the instructor and student can communicate in real-time;
(b) referring students to a web site to review material related to the real-estate subject matter;
(c) providing materials to the student, without the necessity of the network, wherein the materials relate to the real-estate subject matter; and
(d) instructing the student to obtain additional information relating to the real-estate subject matter from the broker with which the student is affiliated.

20. The method of claim 19 further comprising providing materials to the broker relating to the real-estate subject matter provided during step (a).

21. The method of claim 19 further comprising providing the broker with access to a database storing information relating to the student's performance.
